(19) United States
(12) Patent Application Publication
(10) Pub. No.: US 2025/0066141 A1
(43) Pub. Date: Feb. 27, 2025

(54) PROCESS FOR MOVING PACKAGES AND MANIPULATOR FOR PACKAGES PROVIDED TO OPERATE ACCORDING TO THIS PROCESS

(71) Applicant: R.A JONES & CO., Covington, KY (US)

(72) Inventors: Andrea BIONDI, Bologna (IT); Luca CAVAZZA, Bologna (IT); Ivanoe BERTUZZI, Bologna (IT); Cristian DAKESSIAN, Bologna (IT)

(21) Appl. No.: 18/724,123

(22) PCT Filed: Dec. 20, 2022
(86) PCT No.: PCT/IB2022/062553

§ 371 Date: Jun. 25, 2024

(30) Foreign Application Priority Data
Dec. 29, 2021 (IT) 102021000032927

(51) Int. Cl. B65G 47/91

(52) U.S. Cl. CPC B65G 47/91; B65G 2201/0235

(57) ABSTRACT

A process for moving packages involving a pair of gripping elements mounted on a manipulator moving from an open configuration to a gripping configuration to grasp one of said packages. Each package has a box-like body having an opening at a front end of the package and/or a rear end of the package. Furthermore, the process involves at least partially obstructing the opening with at least one obstruction element extended from one of the gripping elements, moving the package by displacing the manipulator along a predefined path and, finally, releasing the package.

The present invention relates to a process for moving packages with a box-like body. It also relates to a manipulator for packages with a box-like body and a related packaging apparatus. The contents of Italian Patent Application No. 102021000032936, filed on 29 Dec. 2021 by the same Applicant, entitled “Manipulator for packages and related process for boxing packages”, are deemed to be incorporated herein in their entirety.

The present invention has a preferred, though not exclusive, application in the field of forming packages with a box-like body for boxing products with variable geometry, in turn containing items, which may be food items or otherwise. An example of products with variable geometry is bags of cereal, e.g. oat flakes or puffed rice, which can be referred to later without loss of generality.

In particular, in this technical sector, processes are known for moving packages with a box-like body, for simplicity's sake also referred to as packages, based mainly on the use of conveyor belts, in which the boxing step is carried out by means of an element that pushes the product, e.g. a cereal bag, into a package with a box-like body, also definable as a pre-formed rigid box, comprising one or more openings through which the bag is inserted and which is closed by means of folding devices arranged along the conveyor belts.

Alternatively, some systems envisage boxing the product with variable geometry by depositing it in a mandrel and wrapping a cardboard blank around the mandrel to form the box-like body of the package (so-called “wrap-around” process).

Typically, in cereal bag packaging equipment, the cereal bags are moved on linear conveyor belts and, if necessary, they pass from one belt to another by gravity. Furthermore, the transport of the bag inside the package and the closing of the package takes place along linear conveyor belts, equipped with folding and gluing devices at their side ends.

In the present description as well as in the accompanying claims, certain terms and expressions are deemed to have the meaning expressed in the following definitions, unless expressly stated otherwise.

A product is said to have “variable geometry” when, due to the nature of the material it contains, the product does not have a defined shape. In particular, the product may be a bag or pouch containing loose material, e.g. granular material or flakes or powder, or material in liquid form. The term “adhesion element” referring to a manipulator means a retaining element capable of retaining an object by contact, specifically it can be suction cups or magnets, Velcro and/or surfaces coated with temporary glues.

“Vertical” or “vertically” refers to a direction parallel to the direction defined by the force of gravity or deviating from the direction defined by the force of gravity by a maximum of 10°; “lowering” refers to a vertical displacement with a direction concordant to gravity, “lifting” refers to a vertical displacement with a direction discordant to gravity.

“Horizontal” or “horizontally” means a direction belonging to a plane perpendicular to the direction of the force of gravity.

“Gripping configuration” means a closed configuration of gripping elements, in which the gripping elements are brought closer together so that a package can be gripped.

“Open configuration” refers to a configuration in which the gripping elements are spaced apart with respect the gripping configuration so that a package cannot be gripped.

The Applicant first noted that the movement of a package containing a product inside, but not yet closed at its longitudinal ends, can be a critical factor in the packaging process. In fact, in this configuration, the product is potentially able to escape from the open box and this unwanted event could cause serious damage to the product and even stop production.

In particular, the Applicant verified that such an eventuality becomes highly probable whenever the moving of the package involves a curvilinear trajectory, where the product's escape from the package may be favoured by the action of centrifugal force.

The Applicant also verified that in high-capacity boxing processes, the use of rotary type transfer devices is preferred, which can operate continuously, advantageously preventing mechanical complications and slowdowns due to the acceleration and deceleration phases of discontinuous type transfer devices. Usually, transfer devices of the rotating type are called carousels.

The Applicant noted, however, that the movement of packages with still open box-like bodies containing products with variable geometry by gripper-type manipulators mounted on a carousel can result in the product contained therein escaping, particularly when high production speeds are required.

The Applicant therefore realised that the escape of products from the packages during the movement of the packs even along a curvilinear path, without placing substantial limitations on the movement speed, can be prevented by providing obstruction elements capable of obstructing the opening of the packs.

The Applicant finally found that the process of moving packages with box-like bodies not closed yet and containing products could be optimised by the provision of a manipulator comprising two gripping elements, e.g. of the gripper type, and at least one obstruction element suitably extended from one of those gripping elements and configured to obstruct the opening of the package.

This solution makes it possible to move said packages with box-like bodies between two conveyor belts or generally between a starting point and an arrival point, avoiding dropping a product contained in said package with a box-like body when it is not yet fully closed.

Thus, in a first aspect thereof, the present invention relates to a process for moving packages.

Preferably, such packages have a box-like body extended longitudinally between a front and a rear end.

Preferably, said box-like body has an opening at at least one of said front and rear ends.

Preferably, said process comprises the step of providing a manipulator on which a pair of gripping elements is mounted in an open configuration.

Preferably, said process comprises the step of gripping one of said packages through said manipulator by moving the gripping elements into a gripping configuration.

Preferably, said process comprises the step of at least partially obstructing said opening with at least one obstruction element.

Preferably, said obstruction element extends from one of said gripping elements.

Preferably, said process comprises the step of moving said package by displacing said manipulator along a predefined path.

Preferably, said process comprises the step of releasing said package.

In a second aspect thereof, the present invention relates to a manipulator for packages.

Preferably this manipulator is moved along a predefined path comprising at least one curvilinear section.

Preferably, the packages comprise a box-like body longitudinally extended between a front end, radially external to said curvilinear section, and a rear end, radially internal to said curvilinear section.

Preferably, said box-like body has an opening at at least said front end.

Preferably, said manipulator comprises a pair of gripping elements cooperating with each other to grip one of said packages.

Preferably, said gripping elements are movable along a movement trajectory from an open to a gripping configuration and vice versa.

Preferably, each of said gripping elements comprises a first end region, radially external with respect to said curvilinear tract, and a second end region, longitudinally opposed to the first end region and radially internal with respect to said curvilinear tract.

Preferably, each of said gripping elements comprises at least one obstruction element extended from said first end region towards the other gripping element.

Preferably, said at least one obstruction element is configured so as to obstruct, at least partially, said opening when the gripping elements grip a respective package.

In a third aspect thereof, the present invention relates to a manipulator for packages.

Preferably, the packages comprise a box body extended longitudinally between a front and a rear end.

Preferably, said box-like body has an opening at at least one of said front and rear ends.

Preferably, said manipulator comprises a pair of gripping elements cooperating with each other to grip one of said packages.

Preferably, said gripping elements are movable along a movement trajectory from an open to a gripping configuration and vice versa.

Preferably, at least one of said gripping elements comprises a first end region and a second end region longitudinally opposed to the first end region.

Preferably, said at least one of said gripping elements comprises a first obstruction element extended from said first end region towards the other gripping element.

Preferably, said first obstruction element is configured to at least partially obstruct said opening, if present in said front end, when said gripping elements grasp a respective package.

Preferably, said at least one of said gripping elements includes a second obstructing element extended from said second end region towards the other gripping element.

Preferably, said second obstruction element is configured to at least partially obstruct said opening, if present in said rear end, when said gripping elements grasp a respective package. Thanks to these features, it is possible to move packages containing a product even on curvilinear trajectories without any particular speed limitations, minimising damage to the product contained and minimising packages being discarded or lost during movement.

In a fourth aspect thereof, the present invention relates to an apparatus for packaging packages with a box-like body comprising a manipulator according to the second or third aspect.

Preferably, in said apparatus, said manipulator is mounted on a carousel.

In at least one of the aforesaid aspects, the present invention can further have at least one of the preferred features described below.

In some embodiments, while said gripping elements are moved into said gripping configuration, said obstruction element at least partially obstructs said opening.

In this way, the action of grasping the pack and obstructing the opening, occur simultaneously, reducing the boxing and moving time, and preventing the products contained in the pack from escaping, even at high production speeds of the apparatus.

Preferably, a longitudinal direction of said box-like body remains defined between said front end and said rear end.

Preferably, said manipulator passes from said open configuration to said gripping configuration or vice versa by rotating the gripping elements about at least one axis of rotation substantially parallel to said longitudinal direction.

Preferably, said manipulator passes from said open configuration to said gripping configuration or vice versa by rotating each of said gripping elements about a respective axis of rotation substantially parallel to said longitudinal direction.

Preferably, said package is moved by said manipulator substantially within a geometric plane.

In this way, it is the manipulator that changes its position according to the geometric plane on which said package is to move, so that the package is moved as smoothly and evenly as possible. Preferably, said geometric plane is a horizontal geometric plane.

Preferably, said gripping elements move from said open configuration to said gripping configuration and vice versa by rotating about at least one axis of rotation substantially parallel to said geometric plane, more preferably each gripping element is rotated about a respective axis of rotation substantially parallel to said geometric plane.

Advantageously, the rotation of said gripping elements about said axis of rotation allows the manipulator's footprint to be minimised depending on the size of said package.

Furthermore, the rotation of said gripping elements about said axis of rotation allows said manipulator to easily adapt to the dimensions of said package.

Preferably, said predefined path is curvilinear in at least one of its sections.

Preferably, said curvilinear section is an arc of a circle.

Preferably, said package is released by moving said gripping elements into an open configuration.

Preferably, said package includes a wing at at least one of said ends and said opening is at least partially obstructed by folding said wing through said obstruction element.

Preferably, said package contains a product.

Preferably, said product is a variable geometry product.

Preferably, said package is released from said manipulator onto a conveyor belt.

Preferably, said package is released from said manipulator with a predefined conformation on a conveyor belt.

Preferably, said conveyor belt comprises containment elements.

Preferably, said containment elements are designed to keep said package in said predefined conformation.

Preferably, said gripping elements are shaped so as not to interfere with said containment elements of said conveyor belt.

In this way, the release of the package takes place close to the conveyor belt, even at high speeds, keeping the package in the conformation conferred by the manipulator and, at the same time, avoiding possible interference between the manipulator and the containment elements, also known as carriers.

Preferably, said gripping elements move from said open configuration to said gripping configuration or vice versa by rotating about respective axes of rotation substantially parallel to a plane of said conveyor belt onto which said packages are released.

In some embodiments, each of said gripping elements comprises a second obstruction element. Preferably, said second obstruction element is extended from said second end region towards the other gripping element.

Preferably, each of said gripping elements comprises a main body extended longitudinally between said first end region and said second end region.

Preferably, a plurality of prongs extend from said main body, said prongs being configured to abut said package when grasped by said gripping elements.

Preferably, said prongs are substantially perpendicular to said movement trajectory.

Preferably, said prongs are moveable along the main body.

In this way, the dimensions of the gripping elements can be adjusted according to the size of the package to be moved.

Preferably, said first obstruction element is extended from a prong of one gripping element towards the other gripping element, at said first end region.

Preferably second obstruction element is extended from a prong of one gripping element towards the other gripping element, at said second end region.

Preferably, said prongs are distributed so as to abut said package along opposing side walls, extended longitudinally between said front end and said rear end. Preferably at least some of said prongs abut said side walls at one of their median regions.

Preferably, a plurality of adhesion elements is interposed between said gripping elements.

In some embodiments, said package is released by separating it from the adhesion elements and opening the gripping elements.

Preferably, the separation of the adhesion elements from the package and the opening of the gripping elements take place simultaneously.

In this way, the substantial simultaneity of the two actions allows high production speeds to be maintained, minimising moving times.

In this way, at high production speeds and/or predefined curvilinear paths, the adhesion elements hold the pack during its movement by the manipulator, preventing it from escaping from the gripping elements, causing the pack and the product to be rejected or, worse, a momentary production stop.

Furthermore, the combined action of the adhesion elements and the gripping elements allows for a more secure retention of the package than the presence of the adhesion elements alone, and this aspect is more relevant in the case of products of a granular nature that may generate dust that could compromise the proper retention of the adhesion elements.

In some embodiments, the adhesion elements are one of suction cups, magnetic elements, velcro or a combination thereof, more preferably suction cups.

Preferably, said suction cups are adhered to said package, depressurizing it through a suction circuit.

Preferably, said suction cup circuit comprises a pump and a control unit.

Alternatively, said suction cup circuit comprises a Venturi effect generator and a control unit.

Preferably said control unit is a solenoid valve.

This allows the suction cups to be easily switched on and off, controlling the suction flow.

Preferably, said manipulator is connected to said carousel via an electromechanical arm.

Preferably, the suction cup circuit is mounted on said electromechanical arm.

In some embodiments, the product contained in the package is a pouch containing loose material, e.g. cereal.

Preferably, this manipulator also comprises two rotational actuators, each connected to a respective gripping element.

According to some embodiments, such rotational actuators, in addition to being free to rotate each about said respective axis of rotation, can also be displaced horizontally depending on the transverse dimension of the package to be grasped. It should be noted that some steps of the above-described process may be independent of the order of execution reported, unless it is expressly indicated that sequentiality or simultaneity between two or more steps is necessary. In addition, some steps may be optional. Furthermore, some steps of the process can be performed repetitively, or can be performed in series or in parallel with other steps of the process.

The characteristics and advantages of the invention will become clearer from the detailed description of an embodiment illustrated, by way of non limiting example, with reference to the appended drawings wherein:

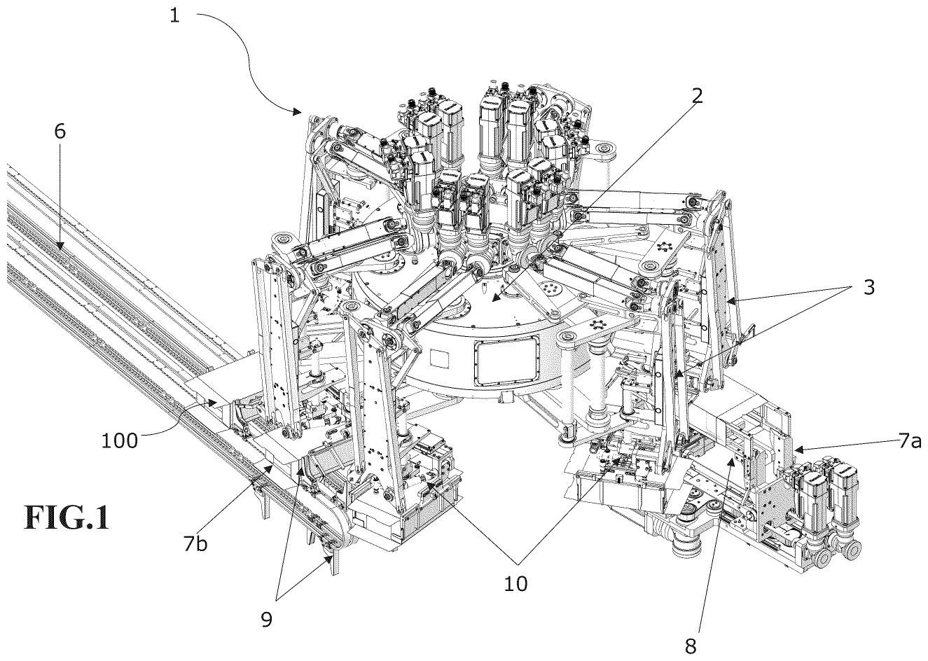

FIG. 1 is a perspective view of an apparatus for moving packages with a box-like body provided with manipulators manufactured in accordance with the present solution;

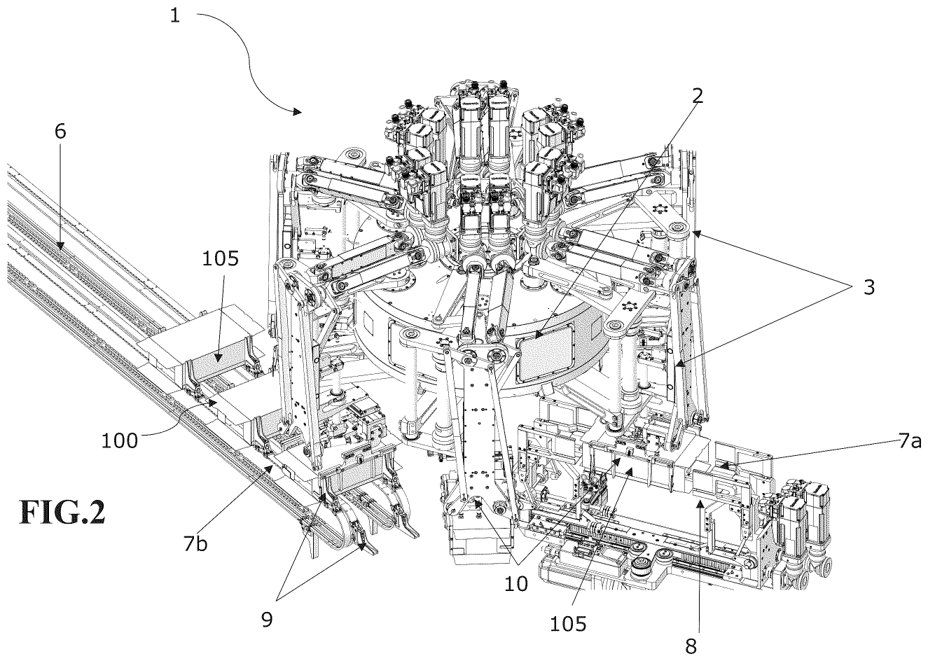

FIG. 2 is another perspective view of the apparatus of FIG. 1;

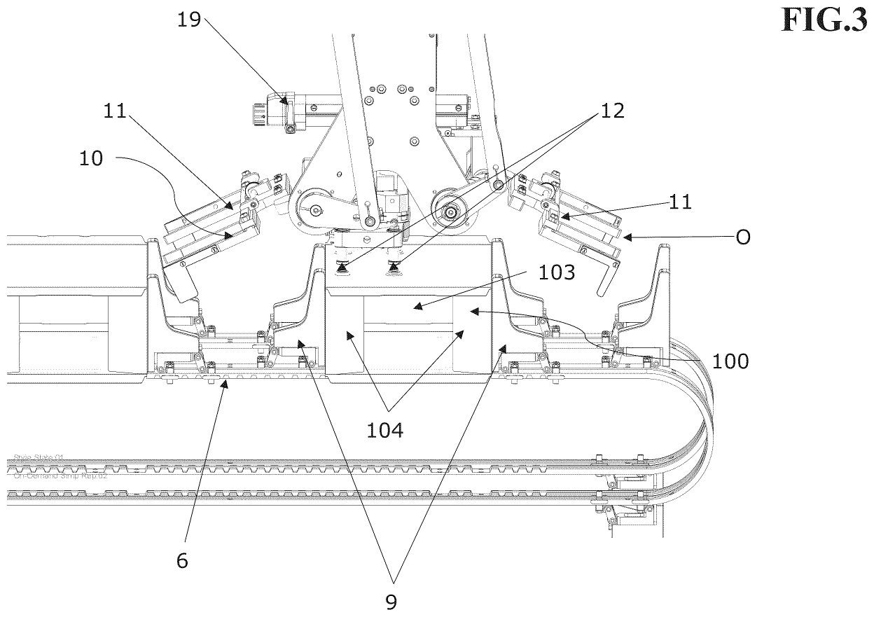

FIG. 3 is a perspective view of the manipulator of FIG. 1 with the gripping elements in an open configuration, in a step of releasing the package onto a conveyor belt;

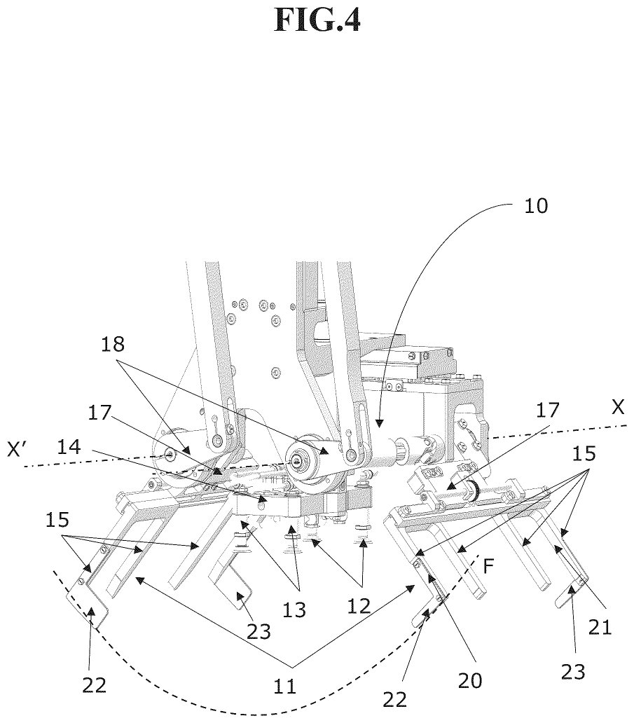

FIG. 4 is a perspective view of the manipulator of FIG. 1 with the gripping elements in an intermediate configuration between the open configuration and the gripping configuration;

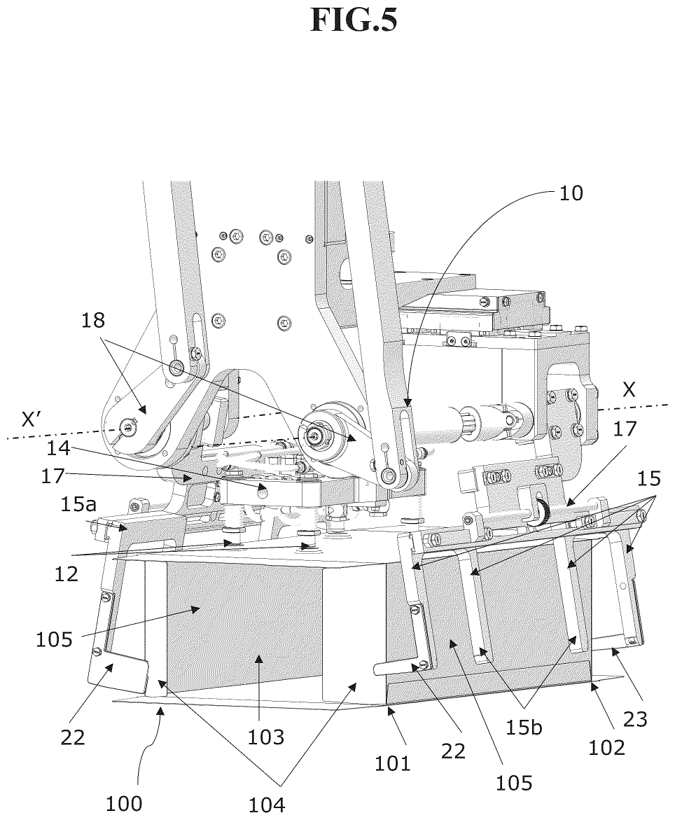

FIG. 5 is a perspective view of the manipulator of FIG. 1 with the gripping elements in an intermediate configuration between the open configuration and the gripping configuration around a box-like body;

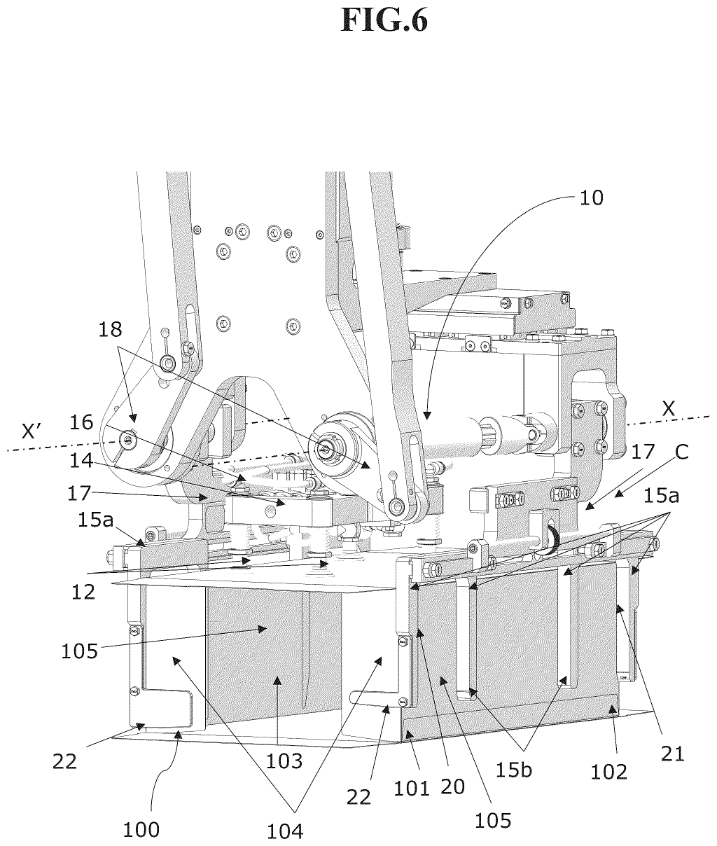

FIG. 6 is a perspective view of the manipulator of FIG. 1 with the gripping elements in a gripping configuration around a box-like body.

With reference to the appended figures, 1 indicates an apparatus for moving packages 100 with a box-like body, for simplicity's sake also called packages 100, for boxing products with variable geometry (not shown in the figure for the sake of clarity), manufactured in accordance with the present solution.

In the preferred case described herein, the products with variable geometry are bags containing cereals that must be moved between a starting point 7a and an arrival point 7b.

For this purpose, the apparatus 1 comprises a carousel 2, rotating about a vertical axis, on which a plurality of manipulators 10 are mounted via respective electromechanical arms 3.

Each arm 3 comprises a first end connected to the carousel 2 and a second end connected to the manipulator 10.

The electromechanical arms 3 have three degrees of freedom allowing the vertical, horizontal and rotational displacement of each manipulator 10. Each electromechanical arm 3 can assume different positions during each revolution of the carousel 2: a radial position relative to the axis of rotation of said carousel 2, or a position that deviates from the radial position by an angle comprised between −60° and +60°. This position variation allows said arm 3 to vary its rotational speed during each revolution of the carousel 2.

In the preferred case described herein, the apparatus 1 comprises at least one mandrel 8, which arrives in proximity to the carousel 2 and from which the manipulator 10 picks up from the mandrel 8 a package 100 at a point in the trajectory of the mandrel 8 which defines the starting point 7a of the movement of the packages 100 by the manipulator 10.

The mandrel 8 moves along a curvilinear trajectory.

In the preferred case described herein, the apparatus 1 also comprises a conveyor belt 6 in which the manipulator 10 deposits the package 100. The conveyor belt 6 thus defines the arrival point 7b of the movement of the packages 100 by the manipulator 10.

The conveyor belt 6 in turn comprises containment elements 9, also known as carriers, arranged equally spaced apart along the conveyor belt 6, between which the 100 packages with box-like bodies are released.

Advantageously, the change in rotational speed allows the arm 3 to stay longer at the starting point 7a and the arrival point 7b in order to pick up and release the package 100 while minimising impacts and damage to the product contained in the package 100.

The variation in rotational speed also allows the manipulator 10 to couple with said containment elements 9 during the release of the package 100 with a box-like body.

Each manipulator 10 is moved between the starting point 7a and the arrival point 7b along a path defined essentially by an arc of a circle, centred on the axis of rotation of the carousel 2.

Each manipulator 10 comprises a pair of gripping elements 11 cooperating with each other to grasp a package 100. For this purpose, the gripping elements 11 are movable along a movement trajectory F from an open configuration O to a gripping configuration C and vice versa.

In the preferred case described herein, the packages 100 have a box-like body extended along a longitudinal direction between a front end 101, radially external with respect to said curvilinear section, and a rear end 102, radially internal with respect to said curvilinear section, with an opening 103 at each of said ends 101, 102. Each package 100 further comprises, at both ends 101, 102, respective pairs of wings 104 extended from the side panels of the package 100 and capable of being folded to at least partially close the respective opening 103.

The gripping elements 11 move from the open configuration O to the gripping configuration C or vice versa by rotating about their respective horizontal axes of rotation axes X, X′. The axes of rotation X, X′ are thus substantially parallel to the plane of the conveyor belt 6 onto which the packages 100 are released.

In particular, said axes of rotation X, X′ are oriented so as to be substantially parallel to the longitudinal direction of the package 100 which they move, so that each gripping element 11, when moved in the gripping configuration C, abuts the package 100, at respective side walls 105 extended longitudinally between the ends 101, 102.

The manipulator 10 further comprises a first end region 20, radially external with respect to the curvilinear section of the predefined path along which the package 100 is displaced by the manipulator 10, and a second end region 21, longitudinally opposed to the first end region 20 and radially internal with respect to said curvilinear section.

The manipulator 10 further comprises, for each gripping element 11, a first obstruction element 22 extended from the first end region 20 towards the other gripping element 11, configured to at least partially obstruct the opening 103 present in the front end 101, when the gripping elements 11 grasp a respective package 100; a second obstruction element 23 extended from the second end region 21 towards the other gripping element 11, configured to at least partially obstruct the opening 103 present in the rear end 102, when the gripping elements 11 grasp a respective package 100.

The manipulator 10 also comprises a plurality of adhesion elements 12, interposed between the gripping elements 11. Each adhesion element 12 is mounted on a respective elastic support 13. In the preferred case described herein, the adhesion elements 12 are suction cups connected to a suction circuit 16 while the elastic supports 13 are springs.

The suction cups and their respective springs are mounted on a plate 14 with an adjustable position in relation to the gripping elements 11.

The plate 14 is rectangular in shape and there are four suction cups and their respective springs, which are arranged symmetrically on the plate 14, in particular they are equally spaced from the axes of symmetry of the plate 14.

Each gripping element 11 also comprises a main body 17 to which a pair of rotational actuators 18 is rotatably connected, which, by means of a system of articulated levers, control the rotation of the gripping elements 11 about the respective axes of rotation X, X′.

In addition, each of said gripping elements 11 comprises four prongs 15, extending from the main body 17, substantially perpendicular to the movement trajectory F of the gripping elements 11.

The prongs 15 comprise an attachment end 15a, proximal to the main body 17 and a free end 15b, distal with respect to the main body 17.

The prongs 15 are advantageously movable two by two along the respective main body 17 so as to longitudinally distance or approach the first end region 20 and the second end region 21 along the longitudinal direction of the gripping element 11.

On each gripping element 11, the first obstruction element 22 extends from the free end 15b of the prong 15 at said first end region 20, towards the other gripping element 11; the second obstruction element 23 extends from the free end 15b of the prong 15 at said second end region 21, towards the other gripping element 11.

These gripping elements 11 of the manipulator 10 are shaped so as not to interfere with the containment elements 9.

The plate 14 to which the suction cups with their respective springs are connected is vertically slidable by means of a vertical actuator 19 mounted on the electromechanical arm 3.

The suction circuit 16 of the suction cups comprises a pump and a control unit installed on said arm 3.

To move the packages 100, the manipulator 10, with the gripping elements 11 in the open configuration O, is brought by the carousel 2 close to the starting point 7a, i.e. at a mandrel 8 containing the product to be packaged and around which the box-like body of the package 100 has been formed.

At this point, the package 100 contained in the mandrel 8 is grasped via the manipulator 10 by rotating the gripping elements 11 about their respective axes of rotation X and X′ so as to move them along the movement trajectory F from the open configuration O to the gripping configuration C, where the prongs 15 abut the package 100 at the respective side walls 105.

During this displacement, the obstruction elements 22 and 23 of each gripping element 11 abut a respective wing 104 of the package 100, folding it towards the opening 103 (FIG. 5). Thus, when the gripping elements 11 end their movement towards the gripping configuration C, the openings 103 provided at the opposing front and rear ends 101 and 102 are at least partially obstructed by the wings 104 (FIG. 6).

In this way, the product contained in the package 100 is prevented from escaping through the opening 103 and, in particular, through the opening 103 of the front end 101 of the package 100 which is in a radially external position with respect to the rotational movement of the manipulator 10.

At the same time, the suction cups 12 are activated, so that the package 100 is further retained from above.

The package 100 is then displaced from the mandrel 8 to the conveyor belt 6, moving the manipulator 10 along the curvilinear path defined by the rotation of the carousel 2. It will be noted that the product contained in the package 100, although pushed outwards by the centrifugal force due to the curvilinear path of the manipulator 10, is retained inside the package 100 by the presence of the wings 104 and the first obstructing elements 22 which hold them in the closed position.

Similarly, product escape from the rear end opening 102 is prevented by the wings 104 being closed and held in the closed position by the second obstruction elements 23.

It will also be seen that the package 100 is grasped by the gripping elements 11 at the side walls 105 and held by the suction cups 12 at its upper face, so that it can be moved effectively and safely from the mandrel 8 to the conveyor belt 6 while remaining suspended in the air.

Upon reaching the arrival point 7b, at the conveyor belt 6, the manipulator 10 releases the package 100, deactivating the suction cups 12 and moving the gripping elements to the open configuration O.

In particular, the release of the package takes place between two rows of containment elements 9, so that the square shape of the package imposed by the manipulator 10 is also maintained in the subsequent movement along the conveyor belt 6.

1.-18. (canceled)

19. A process for moving packages, each package having a box-like body extended longitudinally between a front end of each package and a rear end of each package, said box-like body having an opening at least at one of said front end and rear end, the process comprising:
providing a manipulator on which a pair of gripping elements is mounted in an open configuration;
grasping a respective package with said manipulator by displacing the gripping elements into a gripping configuration;
at least partially obstructing said opening with at least one obstruction element extended from one of said gripping elements;
moving said respective package by displacing said manipulator along a predefined path; and
releasing said respective package.

20. The process according to claim 19, wherein while said gripping elements are displaced into said gripping configuration, said obstruction element at least partially obstructs said opening.

21. The process according to claim 19, wherein said respective package is moved by said manipulator within a geometric plane.

22. The process according to claim 21, wherein said geometric plane is a horizontal geometric plane.

23. The process according to claim 19, wherein said predefined path is curvilinear in at least one section thereof.

24. The process according to claim 19, wherein the releasing said respective package comprises displacing said gripping elements into said open configuration.

25. The process according to claim 19, wherein:
said respective package comprises a wing at least at one of said front end and rear end, and
at least partially obstructing said opening comprises folding said wing through said at least one obstruction element.

26. The process according to claim 19, wherein said respective package contains a product.

27. The process according to claim 19, wherein releasing said respective package comprises releasing said respective package with a predefined conformation by said manipulator on to a conveyor belt comprising containment elements, said containment elements being provided to maintain said respective package in said predefined conformation.

28. The process according to claim 27, wherein said gripping elements are shaped to not interfere with said containment elements of said conveyor belt.

29. A manipulator for packages, each package comprising a box-like body extending longitudinally between a front end of the package, radially external with respect to a curvilinear section of a predefined path, and a rear end of the package, radially internal with respect to said curvilinear section, said box-like body having an opening at least at said front end, said manipulator comprising:
a pair of gripping elements configured to grasp one of said packages, each of said gripping elements comprising:
a first end region, radially external with respect to said curvilinear section, and a second end region, longitudinally opposed to the first end region and radially internal with respect to said curvilinear section, and
at least one obstruction element extended from said first end region towards a different gripping element, configured to at least partially obstruct said opening when the gripping elements grasp a respective package;
wherein:
the manipulator is configured to be moved along the predefined path, and
said gripping elements are configured to move along a movement trajectory between an open configuration and a gripping configuration.

30. The manipulator according to claim 29, wherein each of said gripping elements further comprises a second obstruction element extended from said second end region towards the different gripping element.

31. A manipulator for packages, each package comprising a box-like body extending longitudinally between a front end of the package and a rear end of the package, and having an opening at least at one of said front end and rear end, said manipulator comprising:
a first gripping element and second gripping element cooperating with each other to grasp one of said packages, the first gripping element comprising:
a first end region and a second end region that is longitudinally opposed to the first end region,
a first obstruction element extended from said first end region towards the second gripping element, the first obstruction element configured to at least partially obstruct said opening, if present in said front end, when said first gripping element and said second gripping element grasp a respective package, and
a second obstruction element extended from said second end region towards the second gripping element, the second obstruction element configured to at least partially obstruct said opening, if present in said rear end, when said first gripping element and said second gripping element grasp a respective package;
wherein:
said first gripping element and second gripping element are configured to move along a movement trajectory between an open configuration and a gripping configuration.

32. The manipulator according to claim 31, the second gripping element comprising:
a first end region and a second end region that is longitudinally opposed to the first end region,
a first obstruction element extended from said first end region towards the first gripping element, configured to at least partially obstruct said opening, if present in said front end, when said first gripping element and said second gripping element grasp a respective package, and
a second obstruction element extended from said second end region towards the first gripping element, configured to at least partially obstruct said opening, if present in said rear end, when said first gripping element and said second gripping element grasp a respective package.

33. The manipulator according to claim 29, wherein a plurality of adhesion elements is interposed between said pair of gripping elements.

34. The manipulator according to claim 33, wherein said adhesion elements comprise suction cups.

35. An apparatus for packaging packages with a box-like body comprising a manipulator according to claim 29, wherein said manipulator is mounted on a carousel.

36. The manipulator according to claim 31, wherein a plurality of adhesion elements is interposed between said first gripping element and said second gripping element.

37. The manipulator according to claim 36, wherein said adhesion elements comprise suction cups.
